(19) United States
(12) Patent Application Publication
(10) Pub. No.: US 2011/0113089 A1
(43) Pub. Date: May 12, 2011

(54) DELIVERING MEDIA-RICH-INVITATIONAL CONTENT ON MOBILE DEVICES

(75) Inventors: Eswar Priyadarshan, West Roxbury, MA (US); Ravikiran Chittari, Cupertino, CA (US)

(73) Assignee: Apple Inc., Cupertino, CA (US)

(21) Appl. No.: 12/942,981

(22) Filed: Nov. 9, 2010

Related U.S. Application Data
(60) Provisional application No. 61/259,443, filed on Nov. 9, 2009.

(51) Int. Cl. G06F 15/16

(52) U.S. Cl. 709/203

(57) ABSTRACT

The present technology relates to providing invitational content having enhanced content and capabilities to make the invitational content more engaging and useful for users. Specifically, the invitational content can be configured to call on and utilize core operating system functions, additional web content, and other mobile device applications.

### CROSS-REFERENCE TO RELATED APPLICATIONS

This application claims the benefit of U.S. Provisional Application No. 61/259,443, filed Nov. 9, 2009, entitled “DELIVERING MEDIA-RICH ADVERTISEMENTS ON MOBILE DEVICES,” and expressly incorporates it herein, in its entirety.

### FIELD OF THE TECHNOLOGY

The present technology relates generally to provisioning of invitational content, and more specifically to providing media-rich-invitational content on mobile devices from within mobile applications.

### BACKGROUND

The use of mobile phones in the United States and around the world has increased dramatically. It is projected that soon the number of mobile phone users will exceed the number of fixed telephone subscribers. The proliferation of mobile phone usage has engendered corresponding advances in mobile phone technology. Mobile phones can now handle many types of multimedia content. Consumers can navigate the World Wide Web (the “Web”) from their mobile phones to much the same degree as from their home computers. The proliferation of these new multimedia mobile phone devices has accordingly created a ripe market for content delivery, which both third-party content providers and wireless carrier companies have become increasingly interested in.

However, the content available to mobile devices is often difficult to access and preview before downloading or purchasing. Indeed, most content must be advertised or marketed in some form to the consumer, and listed in a catalog, deck or file for the consumer to access and download. Displaying advertising or marketing information becomes essential for the distribution of any content intended for the mobile device.

Nonetheless, mobile devices, and particularly mobile telephones, tablet computing devices, and PDAs are a practical invitational content delivery medium since many mobile device users spend significant amounts of time with their mobile devices. Much of this time, however, is now spent in “applications” as opposed to merely using the device as a communication device. For example, many consumers utilize their mobile devices as a GPS device, as a portal to various social networking applications, and as a gaming device. Only a small percentage of a user's operation of the device may be spent as an actual communication device. These applications are often developed by third parties (e.g., people other than the device manufacturer or the network provider), and can limit the ability of content developers to reach the end users. Some companies may provide application programming interfaces (APIs) to developers that allow access to content delivery networks or device operating system functionality, but the ability to access multiple content delivery networks and render media-rich content all within the context of an application is not currently supported.

There are also various technical difficulties with invitational content delivery on mobile devices. Some mobile device content requires multiple applications to execute on a mobile device in order to display different content. These multiple applications can sometimes overload a mobile device's operating system, causing the device to malfunction. Some mobile device operating systems cannot automatically initiate an application to display invitational content. Also, many devices are only able to display invitational content through a web/WAP portal, requiring additional transmission time from the user to view the advertising information.

### SUMMARY

Additional features and advantages of the disclosure will be set forth in the description which follows, and in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology relates to providing invitational content having enhanced content and capabilities to make the invitational content more engaging and useful for users. Specifically, the invitational content can be configured to call on and utilize core operating system functions, additional web content, and other mobile device applications.

Such capabilities are also extremely beneficial for invitational content developers. Rather than develop functionalities and content from scratch for each item of invitational content, the invitational content can call on and make use of these functionalities that already exist on the mobile device or applications that are already in existence, whether installed on the mobile device or not.

As an example, if the invitational content is an advertisement, it would be beneficial to a user and a content developer to be able to make use of a map application and a mobile device's GPS functionality to guide a user to a nearby shop that is advertised in the invitational content. Rather than develop a map application for each item of invitational content, it is more efficient to use pre-existing applications. Not only is the development of the invitational content made easier and faster, but the size of the invitational content is reduced and therefore less bandwidth is required to serve the invitational content to the user.

Of course, today there is a wide variety of mobile device hardware and several different mobile device operating systems. Accordingly, invitational content must be appropriate for the mobile device and operating system.

To ensure that invitational content is appropriate for the device and operating system, the present technology also makes use of a content delivery network which can learn of various device features, such as device model and operating system, among others, and serve the appropriate content. In some embodiments, the content delivery network can also provide additional software that is not resident on a device when it is needed.

Several different methods can be used to make use of mobile device operating system functionality or applications installed on the device. In one embodiment, a plug-in can be used along with a browser wherein the plug-in is configured to access operating system data. In some embodiments wherein such operating system data is protected, the operating system itself can have an agent to pass operating system parameters to the invitational content or supporting application. In such environments any supporting application or invitational content can be run in a virtual environment or sandboxed environment but still receive necessary data from the operating system agent.

In some embodiments, before invitational content calls for a supporting application, it can interrogate the device operating system to determine if the desired functionality or supporting application is supported by the device.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary embodiment of a media-rich application that is rendered within another application;

FIG. 2 illustrates an exemplary scheme of interactivity with the invitational-content application;

FIG. 3 illustrates one exemplary approach to delivering media-rich advertising to a mobile device;

FIG. 4 illustrates one exemplary approach to delivering media-rich advertising to a mobile device;

FIG. 5 illustrates one exemplary approach to delivering media-rich advertising to a mobile device;

FIG. 6 illustrates a flow chart illustrating one or more method of the embodiments;

FIG. 7 illustrates one exemplary system embodiment; and

FIG. 8 illustrates a computer system used in executing the described method.

### DETAILED DESCRIPTION

Embodiments of the present technology provide systems and methods for allowing developers of mobile applications (e.g., applications that can be downloaded and executed on a mobile device) to incorporate invitational-content applications into their applications, regardless of the format of the invitational-content application and the content delivery network from which the invitational-content application is being delivered. In other implementations, developers may reference media-rich applications or device operating system functionality from within their application, essentially creating advertisements for one application that is rendered in another.

In the various embodiments, one or more types of invitational content can include text, graphics, audio, video, executable code or any combination thereof. In some embodiments, the invitational content can be associated with a product or can directly or indirectly advertise a product. In some embodiments, the content package can be configured to replace or update invitational content in a content package already delivered to the user terminal.

Further, the invitational content can be active invitational content. That is, invitational content that is designed to primarily elicit a pre-defined response from the user. For example, active invitational content can include one or more types of advertisements configured to be clicked upon, solicit information, or be converted by the user into a further action, such as a purchase or download of the advertised item. However, invitational content can also include passive invitational content. That is, invitational content that is designed to primarily inform the user. In some cases, passive invitational content can include information that can lead or direct users to active invitational content. Additionally, the invitational content can be dynamic invitational content. That is, invitational content that varies over time or that varies based on user interaction with the invitational content. However, the various embodiments are not limited in this regard and the invitational content can be static invitational content that does not vary over time or that varies based on user interaction. In the various embodiments, an invitational content in a content package can be static or dynamic and active or passive. Further, various types of invitational content can be combined in a same content package.

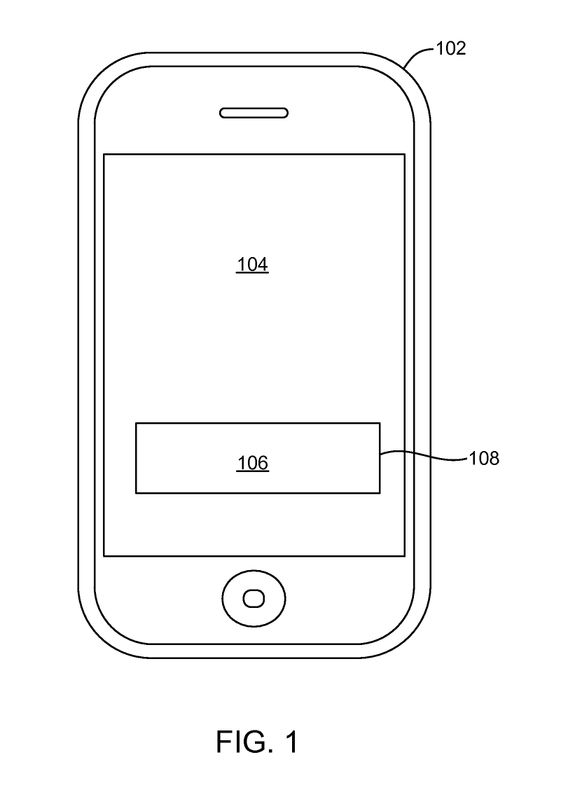

FIG. 1 illustrates an exemplary embodiment of a media-rich application that is rendered within another application. FIG. 1 illustrates an exemplary device 102 displaying a mobile application 104 and invitational-content application 106 in a view 108 within the mobile application 104. As illustrated, the device 102 is a handheld computing device, for example, a smart phone, e.g., an IPHONE, by Apple Inc. of Cupertino, Calif. However, the device 102 can be any mobile computing device such as a personal computer, laptop, or personal media-playing device.

The mobile application 104 can be any application that reserves a view 108 to display an invitational-content application 106. The invitational-content application 106 can be any application having content that is created with an audience in mind and can be targeted to that audience. For example, the invitational-content application can be a game for children; a web application targeted at sports fans; or an advertisement for a movie. In some preferred embodiments, the invitational-content application 106 can have some relationship to the mobile application 104, such as a similarity in the target demographic for the audiences of both applications or in the nature of the content of the applications, etc.

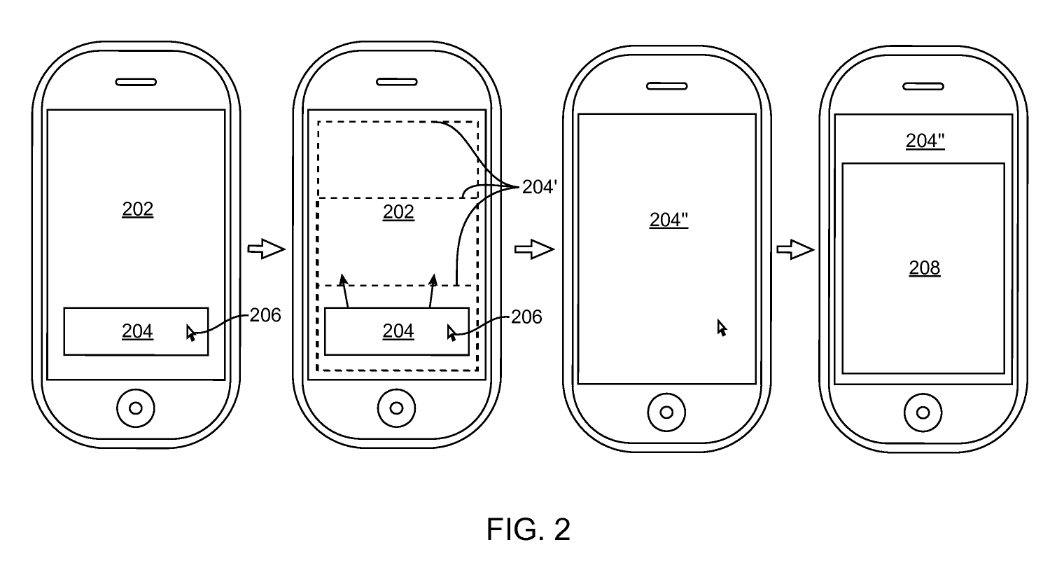

FIG. 2 illustrates an exemplary scheme of interactivity with the invitational-content application. As illustrated in FIG. 2, the invitational-content application 204 is displayed within a view of a mobile application 202, and can be selected using a pointing device 206. In the illustrated embodiment, the pointing device can represent a selection mechanism generically; it can represent a point of touch using a touch screen input device, a mouse input, or any other input device.

Upon selection, the invitational-content application 204, shown in a banner view, expands 204′ to reveal its full view 204″. Upon selecting the banner view, the view displaying invitational-content application 204 expands in an animated fashion into its full view. The invitational-content application can itself morph, or be revealed, or be loaded to fill the available view. 204′ illustrates the transition between the banner view (shown in 204) and the full view (204″).

Regardless of the view, the invitational-content application 204, 204″ can be considered a media-rich application having any one of video, audio, textual, multi-media, or interactive components. As such, the present technology also protects the operating system and the mobile application 202 from unstable and malicious invitational content by running the invitational-content application as a separate process. In some embodiments, the invitational-content application is run in a virtual-machine-type environment or given access to limited resources. In some embodiments, the invitational-content application is run in a sandbox so that it cannot effect the mobile application or operating system. Running the invitational-content application in a sandboxed environment allows the invitational-content application to crash or freeze and be quit without effecting the mobile application. It also prevents the invitational-content application from including malicious content or extracting data from the mobile application. However, in some embodiments the invitational-content application can be granted certain permissions to interact with other hardware or software components on the mobile device as will be addressed in greater detail below.

As also illustrated in FIG. 2, in some embodiments the invitational-content application 204, 204″ can also utilize a supporting application 208. While we use the term “supporting application” herein, such nomenclature does not necessarily mean that the supporting application must support or be related to the invitational-content application or the mobile application. Further, the supporting application does not need to actually be an application or even be displayed. Rather, the supporting application can be an application, or functionality, or content that is called by the invitational-content application.

In some embodiments, the supporting application can be displayed in a view port utilizing a plug-in application or can be its own application operating in a sandbox and displayed within the view port.

To further illustrate how the present technology can enhance a user's experience, FIG. 2 can be discussed in terms of a real world example: A user can be reading news in her mobile news application 202, and invitational-content application 204 advertising a movie can be displayed within the news application 202. If the user wants to learn more about the movie, she can interact with the invitational-content application 204 which can transition to a full screen view 204″ leaving the mobile news application 202 in the background. The full screen view 204″ might be a trailer or other rich content promoting the movie. The user can further interact with the invitational-content application (or can automatically launch) to display a supporting application 208 for purchasing tickets to the movie.

When the supporting application is closed, the user interface can be returned to the invitational content in the same state in which it was in when the supporting application was launched. The same relationship can apply between the invitational-content application and the mobile application. When the invitational-content application is closed, the user interface can be returned to the mobile application in the same state as when then invitational-content application was launched.

In some embodiments the mobile application, the invitational-content application, and the supporting application are each in different formats or each originally written in different code. For example the mobile application might be an objective C application while the invitation content can be an HTML application such as an HTML5 application. As mentioned above, the supporting application need not even be an application; it can be hardware support or hardware input into the invitational-content application (e.g., GPS inputs, compass inputs, accelerometer inputs, camera inputs, etc.). In embodiments wherein the supporting application is an application, it can be a flash application, HTML5 application, objective C or any other type or format of application.

As used herein, mobile devices include, but are not necessarily limited to, electronic-communication devices with Internet access capability. In particular, mobile devices include mobile phones and other wireless-handheld devices, e.g., SmartPhones, such as IPHONE, or BLACKBERRY, Portable-Media-Playing Devices such as IPOD, or ZUNE, and Tablet Computers such as IPAD, or any other type of portable electronic communication device running a mobile operating system platform such as IOS, ANDROID, etc.

In a system for requesting and delivering invitational content on mobile device, the mobile device not only must support the format of the invitational-content application and render it, it also needs to direct the user to the appropriate supporting application should the user interact (e.g., a click, touch, swipe, or other input, often indicating a selection action) with the content. In a conventional system, the invitational-content application is fetched, prepared for viewing on the device, and rendered for viewing. If the user clicks on the content, a mediation client provides the landing URL associated with the content to the device, and a new webview page is opened on the device. However, such an approach fails to take full advantage of the increasing capabilities of mobile devices, and therefore, fails to provide a user with an engaging experience.

In some embodiments the mediation client can also serve as an agent of the operating system to pass parameters from the operating system to the invitational content or supporting application.

However, making use of the full capabilities of mobile devices in the context of invitational content is not straightforward because, due to so many existing mobile device platforms, the format of the invitational-content application being delivered to the device needs to be supported by the device and the necessary application, the application must conform to a published API or a plug-in must reside on the device on which the content is to displayed. Additionally, in some instances, developing features for invitational-content applications or supporting applications can be a waste of resources given the wide variety of applications (apps) that already exist for some mobile device platforms, and given the impressive capabilities built into the operating software for the mobile devices.

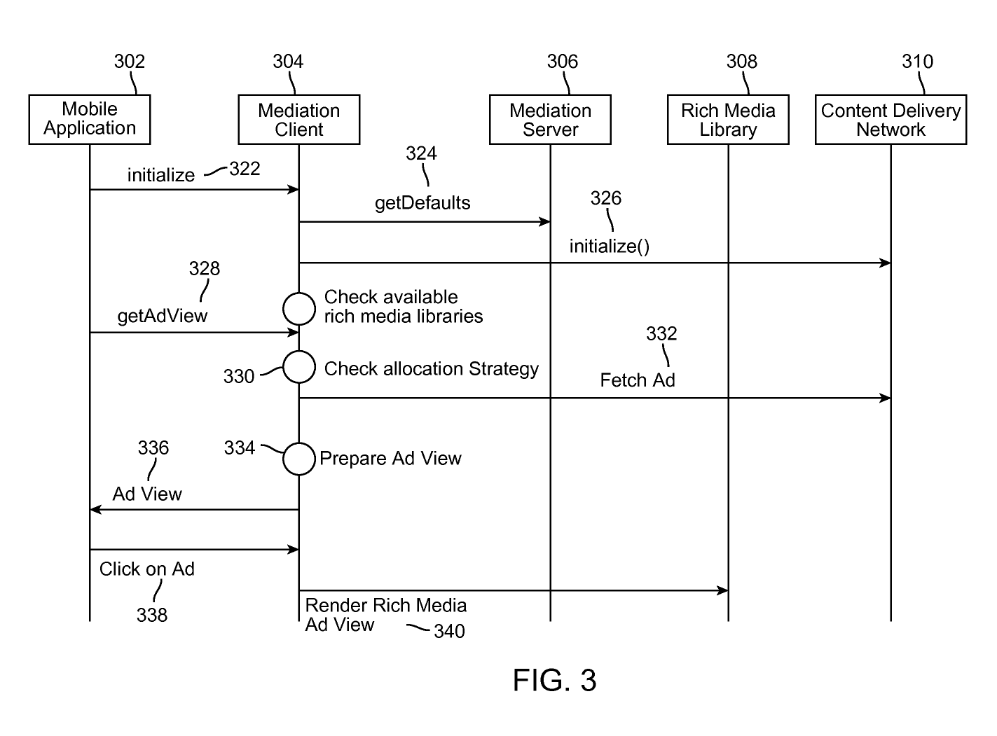

In one embodiment the invitational-content application is configured to access certain mobile device functionality. FIG. 3 illustrates one exemplary approach to delivering media-rich advertising to a mobile device. While components of the system (mobile application 302, mediation client 304, mediation server 306, rich media library 308, and content delivery network 310) are illustrated as separate components, they may be a software or hardware component of the same or separate devices. For example, in some embodiments the mobile application 302 and mediation client 304 can both be components (software or hardware or a combination of both) of the mobile device, and the mediation server 306 and rich media library 308 can be components of the content delivery network 310.

As illustrated in FIG. 3, as the mobile application 302 executes, an initialization process 322 contacts a mediation client which retrieves default parameters 324 of the mobile device and parameters of the view port within the mobile application in which at least an initial view of the invitational content will be displayed (e.g., format, size, etc.) from a mediation server. Further the mediation client can send an initialization message 326 to one or more content delivery networks 310 to inform the networks that a content request is imminent, and to provide certain information about the request. A GetAdView method is called on the device 328, and an allocation strategy is consulted 330 to determine from where the invitational-content application should be retrieved.

Either the mediation client 304 or the mediation server 306, or the combination of the two, can determine the allocation strategy. For example, in cases where multiple content delivery networks are used, the allocation strategy may indicate that an invitational-content application is to be delivered form one network 30% of the time, and from another 70% of the time. In some embodiments, an allocation strategy can be employed even when there is only one content delivery network. For example, the allocation strategy might retrieve invitational content related to branded products 80% of the time, while retrieving invitational content related to cross selling other applications or content that can be downloaded to the mobile device the remaining 20% of the time. The allocation strategies may be based on certain economic parameters of the networks (cost-per-click, cost-per-impression, etc.) as well as information retrieved from the device itself (e.g., location, etc.). The particular allocation ratios or strategies can be device or network dependent, and the disclosure of exemplary strategies herein is not to be considered limiting. Any allocation strategy, including the absence of an allocation strategy is specifically contemplated herein.

Once the allocation strategy, if any, is resolved and a content delivery network from which to request invitational content has been determined, the invitational content is fetched 332. The invitational content is prepared 334 and ultimately viewed 336 within the mobile application 302.

In some embodiments, when the device receives an user input, such as a click 338 on the invitational content, code embedded in the invitational content (typically a script and URL) requests the full invitational content from the rich-media library 308, which then remotely plays 340 the invitational content in an interstitial screen on the device. While in some embodiments, the entire invitational-content application has to be pre-fetched from the content delivery network and the rich-media library.

Regardless of whether the full invitational-content application is retrieved, a user interaction or if it is pre-feteched, the version of the full invitational-content application retrieved from the rich-media library 308, must be configured for the mobile device. While in some aspects, the full invitational-content application can be an HTML application which should be compatible with most mobile devices, the invitational-content application might be configured to utilize certain device functionality (e.g., re-sizing, use of accelerometer parameters, or changes to the aspect or layout of the image, touch screen commands, etc.) to alter the presentation of the invitational content or provide interactive features to the user. In such instances, even though the content can be rendered on the mobile device, the invitational content must be configured to issue the correct commands or calls to access the device functionalities. To account for these diverse-mobile-device operating environments, the rich-media library can send versions of the invitational content configured for the appropriate device.

As addressed above, the invitational-content applications can utilize device functionality. One method of accomplishing such a feature is by taking advantage of functions published in the API (application programming interface) associated with the operating system of the intended device. For example, in one aspect, the invitational-content application can make use of a JavaScript Library that was created and published for this purpose and can extend the functionality of the operating system to the invitational-content application.

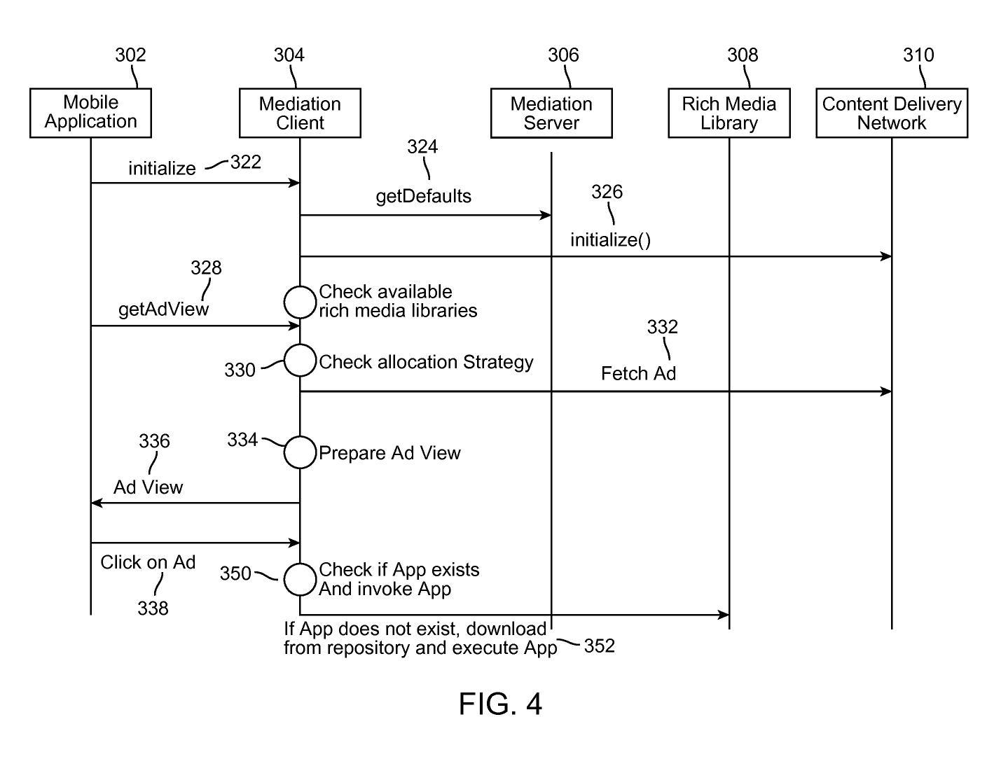

FIG. 4 illustrates an embodiment of the present technology wherein the mobile device does not have the appropriate software to render the invitational content or facilitate appropriate user interactions. FIG. 4 is substantially the same as FIG. 3 in many respects, however, after the mobile device accepts a user input selecting the invitational content, the mediation client determines if the device has the appropriate software to run and render the full invitational content 350. If the appropriate software is present the invitational-content application is launched and if not the required software is downloaded 352 from the rich media library 308. In some embodiments, such determination 350 and download of additional content 352, if required, is carried out before any view of the invitational content is launched. For example, in some embodiments the check can be carried out when the invitational content is originally downloaded and the required software can be pre-feteched for later installation and use if needed. For example, as the user is interacting with a mobile application, she may encounter invitational content for another application. Because the developer of the application wants the invitational content to be as engaging as possible, the invitational content may require a multi-media application to render the invitational content. When the user selects the invitational content, the mediation client determines if the required application resides on the device, and, if not, downloads the application from the application repository. The invitational content can now be viewed on the mobile device in the intended format.

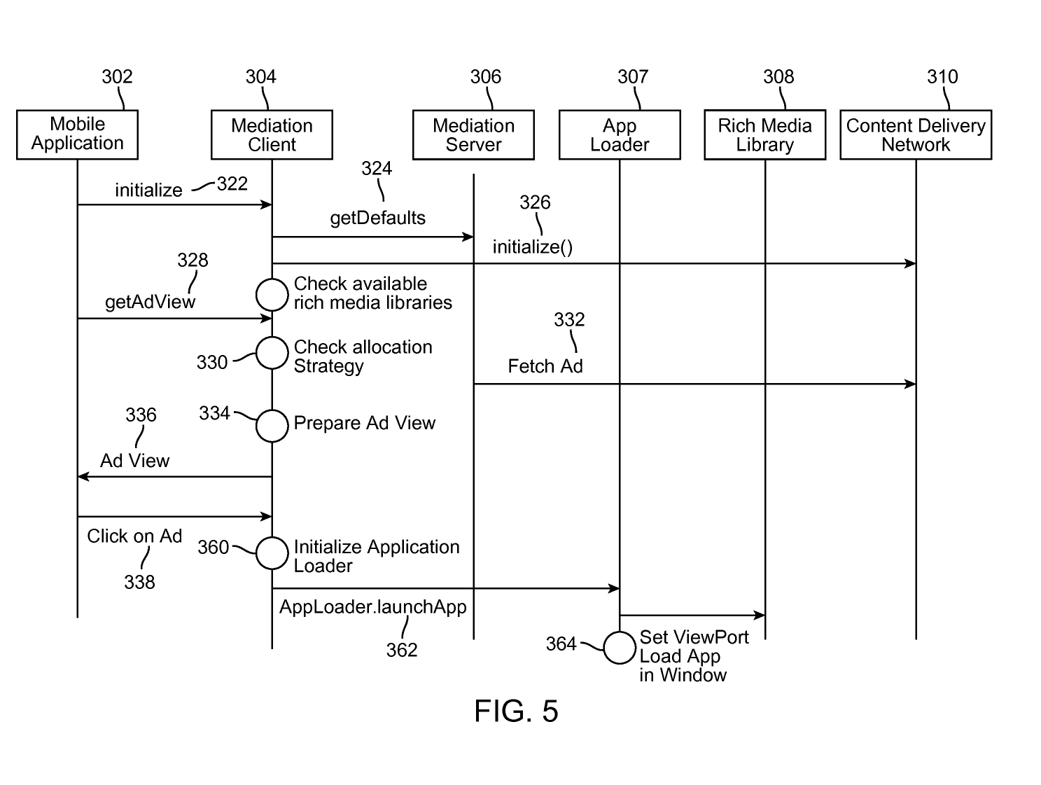

FIG. 5 illustrates and embodiment wherein the invitational content can call and display another application which either resides on the mobile device or is downloaded. As an example, global positioning system (GPS) applications are some of the most popular mobile applications available for smart phones. Some GPS applications provide real-world views of streets and landmarks, in addition to conventional map-based renderings. A user operating a mobile device and using a GPS application to navigate may, in her travels, pass a movie theater showing a particular movie, for which a media-rich creative is available as invitational content. The technology permits the developer of the GPS application to identify placements within the application into which invitational content can be identified such that when encountered by a user, fetches and renders the invitational content containing a creative for the movie on the marquee of the theater. Further, a ticket-purchase application (e.g., FANDANGO) may be referenced on the marquee or by the creative, allowing the user to switch applications and buy tickets to the show, while remembering the application state of the GPS application. This allows the user to return to the GPS application without having to re-launch the application or direct the application back to its prior state.

As illustrated in FIG. 5, after the mobile device accepts a user input 338 within the invitational content, the system facilitates the execution of another application. An application loader 360 is initialized and a launchapp command is given 362, which launches the application 364 in the view port of the invitational-content application.

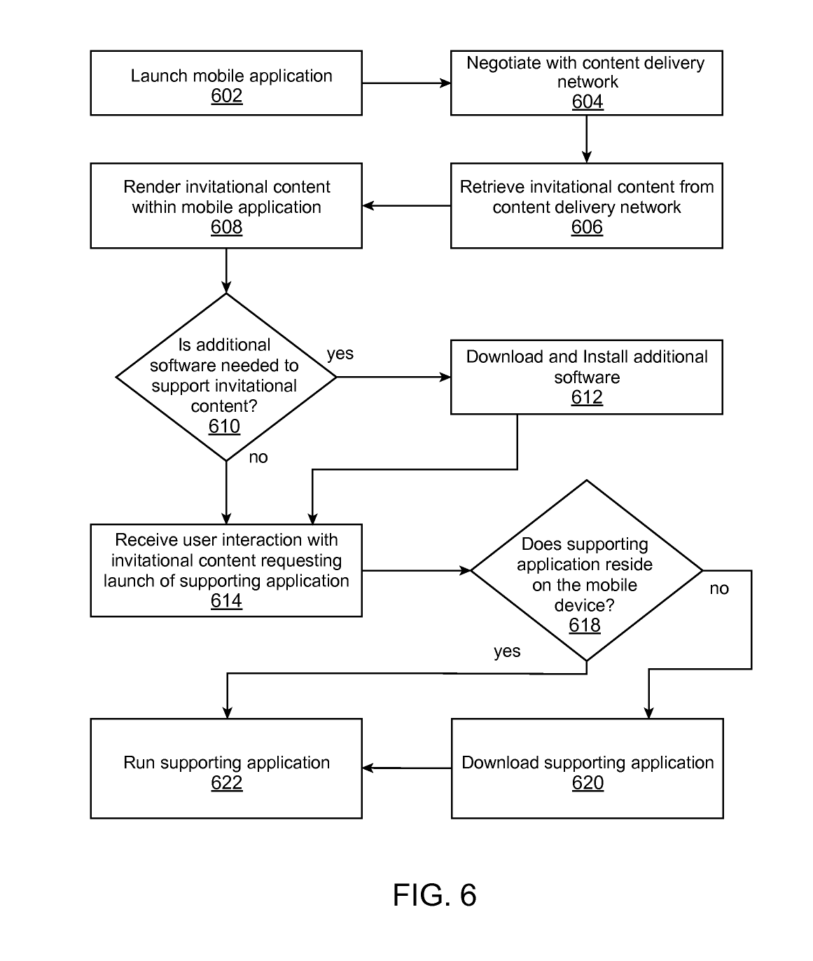

FIG. 6 illustrates a flow chart illustrating some of the embodiments described above. A mobile application is launched (602) on a mobile device, and software and hardware on the mobile device negotiate (604) with a content delivery network to retrieve (606) invitational content suitable for display within the mobile application. The negotiation can include the transfer of information as simple as requesting invitational content, or can be more detailed including information about the mobile device (operating system, hardware capabilities, brand and model, etc.), the application requesting the invitational content, or other information. The negotiation can also include one or more communications between the mobile device and the content delivery network for the purpose of determining which invitational content should be distributed to the mobile application. The invitational content can be downloaded in parts as resources are needed or in a package, such as an archive.

After the invitational content has been downloaded (606), the mobile device can render (608) the invitational content within the mobile application. Software on the mobile device can determine (610) if additional software is needed to support the features of the invitational content. If it is, the additional software is downloaded and installed (612).

In the embodiments wherein the invitational content can utilize a supporting application, the mobile device can receive a user interaction (614) within the invitational content causing the invitational content to request the launch of the supporting application. If the supporting application resides (618) on the mobile device, the application is run (622), but if the supporting application does not exist (618) on the device, the application is downloaded (620), and run (622).

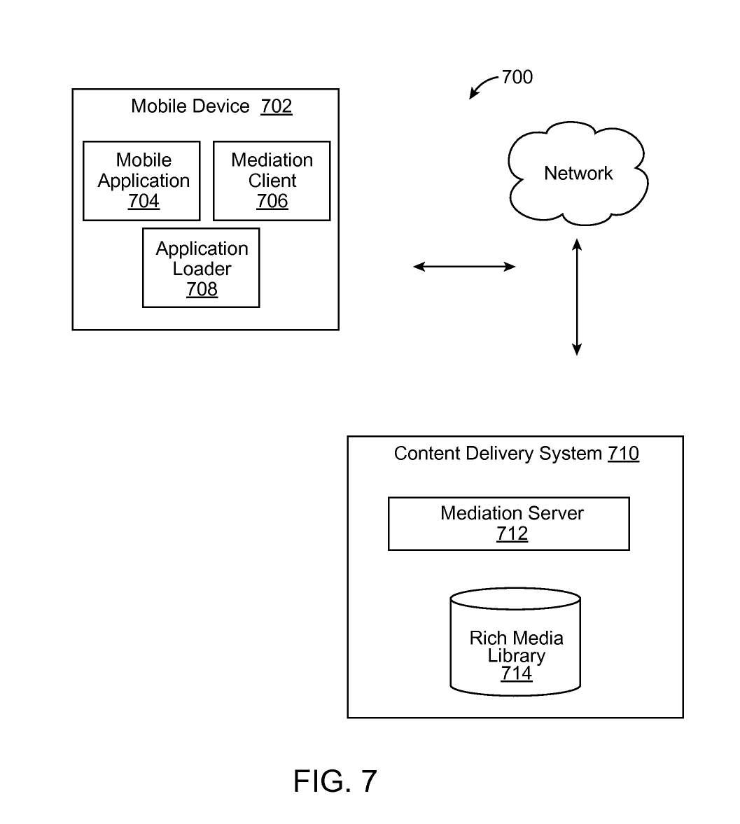

FIG. 7 illustrates one exemplary system embodiment 700 illustrating several modules and components described above. A mobile device 702 is shown in communication with a content delivery system 710. The mobile device includes one or more software modules and hardware components. As illustrated, the mobile device includes a mobile application 704, a mediation client 706, and an application loader 708. The content delivery system 710 is shown including the mediation server 712 and the rich media library 714.

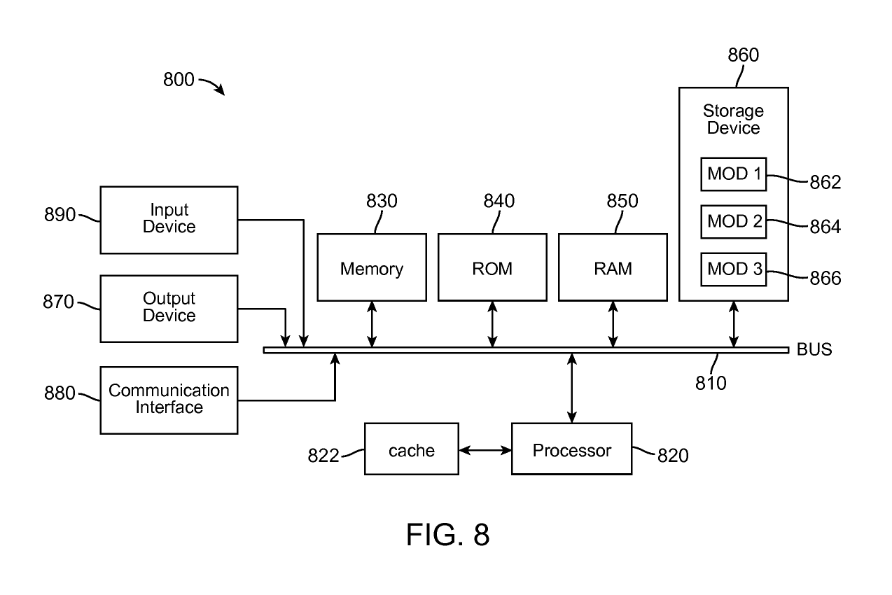

With reference to FIG. 8, an exemplary system 800 includes a general-purpose computing device 800, including a processing unit (CPU or processor) 820 and a system bus 810 that couples various system components including the system memory 830 such as read only memory (ROM) 840 and random access memory (RAM) 850 to the processor 820. The system 800 can include a cache 822 of high speed memory connected directly with, in close proximity to, or integrated as part of the processor 820. The system 800 copies data from the memory 830 and/or the storage device 860 to the cache 822 for quick access by the processor 820. In this way, the cache 822 provides a performance boost that avoids processor 820 delays while waiting for data. These and other modules can be configured to control the processor 820 to perform various actions. Other system memory 830 may be available for use as well. The memory 830 can include multiple different types of memory with different performance characteristics. It can be appreciated that the disclosure may operate on a computing device 800 with more than one processor 820 or on a group or cluster of computing devices networked together to provide greater processing capability. The processor 820 can include any general purpose processor and a hardware module or software module, such as module 1 862, module 2 864, and module 3 866 stored in storage device 860, configured to control the processor 820 as well as a special-purpose processor where software instructions are incorporated into the actual processor design. The processor 820 may essentially be a completely self-contained computing system, containing multiple cores or processors, a bus, memory controller, cache, etc. A multi-core processor may be symmetric or asymmetric.

The system bus 810 may be any of several types of bus structures including a memory bus or memory controller, a peripheral bus, and a local bus using any of a variety of bus architectures. A basic input/output (BIOS) stored in ROM 840 or the like, may provide the basic routine that helps to transfer information between elements within the computing device 800, such as during start-up. The computing device 800 further includes storage devices 860 such as a hard disk drive, a magnetic disk drive, an optical disk drive, tape drive or the like. The storage device 860 can include software modules 862, 864, 866 for controlling the processor 820. Other hardware or software modules are contemplated. The storage device 860 is connected to the system bus 810 by a drive interface. The drives and the associated computer readable storage media provide nonvolatile storage of computer readable instructions, data structures, program modules and other data for the computing device 800. In one aspect, a hardware module that performs a particular function includes the software component stored in a non-transitory computer-readable medium in connection with the necessary hardware components, such as the processor 820, bus 810, display 870, and so forth, to carry out the function. The basic components are known to those of skill in the art and appropriate variations are contemplated depending on the type of device, such as whether the device 800 is a small, handheld computing device, a desktop computer, or a computer server.

Although the exemplary embodiment described herein employs the hard disk 860, it should be appreciated by those skilled in the art that other types of computer readable media which can store data that are accessible by a computer, such as magnetic cassettes, flash memory cards, digital versatile disks, cartridges, random access memories (RAMs) 850, read only memory (ROM) 840, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 800, an input device 890 represents any number of input mechanisms, such as a microphone for speech, a touch-sensitive screen for gesture or graphical input, keyboard, mouse, motion input, speech and so forth. An output device 870 can also be one or more of a number of output mechanisms known to those of skill in the art. In some instances, multimodal systems enable a user to provide multiple types of input to communicate with the computing device 800. The communications interface 880 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 820. The functions these blocks represent may be provided through the use of either shared or dedicated hardware, including, but not limited to, hardware capable of executing software and hardware, such as a processor 820, that is purpose-built to operate as an equivalent to software executing on a general purpose processor. For example the functions of one or more processors presented in FIG. 8 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 840 for storing software performing the operations discussed below, and random access memory (RAM) 850 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 800 shown in FIG. 8 can practice all or part of the recited methods, can be a part of the recited systems, and/or can operate according to instructions in the recited non-transitory computer-readable storage media. Such logical operations can be implemented as modules configured to control the processor 820 to perform particular functions according to the programming of the module. For example,

FIG. 8 illustrates three modules Mod1 862, Mod2 864 and Mod3 866 which are modules controlling the processor 820 to perform particular steps or a series of steps. These modules may be stored on the storage device 860 and loaded into RAM 850 or memory 830 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further, and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
running an mobile application on a mobile device;
requesting a media-rich-invitational-content application by the mobile application for display within the mobile application;
receiving the media-rich-invitational-content application from a content delivery network;
presenting an initial view of the media-rich-invitational-content application in a view port within the mobile application;
accepting interaction with the initial view of the media-rich-invitational content;
presenting a full content view of the media-rich-invitational content and
utilizing by the media-rich-invitational content at least one content enhancing function of the mobile device.

2. The computer-implemented method of claim 1, wherein the viewport is provided by a plug-in application which is configured to access core operating system parameters.

3. The computer-implemented method of claim 1, wherein the utilizing at least one content enhancing function of the mobile device includes initiating a supporting application to run on the mobile device.

4. The computer-implemented method of claim 3, further comprising:
Querying the mobile device if the supporting application is available on the device before initiating the supporting application.

5. The computer-implemented method of claim 3, wherein the supporting application is first downloaded from the content delivery network.

6. The computer-implemented method of claim 3, wherein the media-rich-invitational content is HTML content and the supporting application is displayed as a plug-in.

7. The computer-implemented method of claim 3, wherein the supporting application is run in a sandboxed environment and is viewed in a viewport within the invitational content.

8. The computer-implemented method of claim 1, wherein the full content view of the media-rich-invitational-content application is rendered in the application.

9. The computer-implemented method of claim 1, further comprising:
exiting the full content view of the media-rich-invitational content; and
returning to the application without re-launching the application.

10. The computer-implemented method of claim 7, wherein the application returns to the state that the application was in when the interaction with the initial view of the media-rich-invitational-content application was accepted.

11. The computer-implemented method of claim 1, wherein the full content view of the media-rich-invitational-content application is played from a remote server.

12. The computer-implemented method of claim 1, wherein the utilizing at least one content enhancing function of the mobile device includes accepting inputs form hardware on the handheld communication device.

13. The computer-implemented method of claim 1, wherein the handheld communication device requests, from the content delivery system, media-rich-invitational-content application that is suitable for display on the handheld communication device as determined by the content delivery system based on a known device attribute.

14. The computer-implemented method of claim 1, wherein the utilizing at least one content enhancing function of the mobile device includes utilizing core system functions.

15. A system comprising:
a content delivery network configured to send to a mobile device, an invitational-content application; and
a mobile device configured to request the invitational-content application, the request specifying attributes of the mobile device or operating system, the invitational-content application being selected for the mobile device based on the attributes and being configured to utilize at least one content enhancing function of the mobile device.

16. The system of claim 15, wherein the content enhancing function is a core operating system function.

17. The system of claim 15, wherein the content enhancing function is a supporting application.

18. The system of claim 15, wherein the content enhancing function is a hardware input, in addition to an input from a user input device.

19. A non-transitory computer-readable medium having computer executable instructions stored thereon effective to cause a computer to perform a method comprising:
running a mobile application on a mobile device;
requesting a media-rich-invitational-content application by the mobile application for display within the mobile application;
receiving the media-rich-invitational-content application from a content delivery network;
presenting an initial view of the media-rich-invitational-content application in a view port within the mobile application;
accepting interaction with the initial view of the media-rich-invitational content;
presenting a full content view of the media-rich-invitational content; and
utilizing by the invitational content at least one content enhancing function of the mobile device.

20. The non-transitory computer-readable medium of claim 19, wherein the utilizing at least one content enhancing function of the mobile device includes initiating a supporting application to run on the mobile device.

21. The non-transitory computer-readable medium of claim 19, wherein, wherein the full content view of the media-rich-invitational-content application is rendered in the application.

22. The non-transitory computer-readable medium of claim 19, further comprising:
exiting the full content view of the media-rich-invitational content; and
returning to the application without re-launching the application.

23. The non-transitory computer-readable medium of claim 19, wherein the utilizing at least one content enhancing function of the mobile device includes accepting inputs form hardware on the handheld communication device.

24. The non-transitory computer-readable medium of claim 19, wherein the handheld communication device requests, from the content delivery system, the media-rich-invitational-content application that is suitable for display on the handheld communication device as determined by the content delivery system based on a known device attribute.

25. The non-transitory computer-readable medium of claim 19, wherein the utilizing at least one content enhancing function of the mobile device includes utilizing core system functions.
